(19) United States
(12) Patent Application Publication
(10) Pub. No.: US 2007/0003190 A1
(43) Pub. Date: Jan. 4, 2007

(54) Optical planar splitter

(76) Inventors: Costas Saravanos, Highland Village, TX (US); Elli Makrides-Saravanos, Highland Village, TX (US)

Correspondence Address: CORNING CABLE SYSTEMS LLC, P O BOX 489, HICKORY, NC, 28603, US

(21) Appl. No.: 11/171,915

(22) Filed: Jun. 30, 2005

(51) Int. Cl. G02B 6/30

(52) U.S. Cl. 385/49

(57) ABSTRACT

An optical planar splitter has an optical chip and two fiber arrays attached along the edges of the optical chip. The optical chip has input optical waveguides and output optical waveguides along each of two edges of the optical chip. The optical planar splitter can accommodate several different splitters in the same module, thereby saving valuable space.

### BACKGROUND OF THE INVENTION

1. Field of the Invention

The present invention relates generally to an optical planar splitter that allows for multiple splitters to be included in a single module. The optical planar splitter also allows for inputs and outputs to be along the same edge of an optical chip, which reduces the overall dimensions of the optical chip, allowing for higher densities of optical fibers in compact designs.

2. Technical Background

Communications networks, and particularly high bandwidth optical networks, are being installed closer to the subscribers' homes. However, installing the optical fibers closer to the subscribers' homes can be cost prohibitive. Therefore, the network owners are conscious of the expenses related to installing the optical fibers and the associated equipment further away from the central office and closer to the subscribers. Currently, one expensive component of the network that is limiting the installation of the optical fibers closer to the home is the optical splitter. An optical splitter divides the optical signals into individual signals for the subscribers. Typically, as more subscribers are added to a network, new optical splitters are required in a space that is already relatively crowded. Therefore, a new optical splitter that allows for higher densities of optical fibers in a similar space requirement is needed.

### SUMMARY OF THE INVENTION

To achieve these and other advantages and in accordance with the purpose of the invention as embodied and broadly described herein, the invention is directed in one aspect to an optical planar splitter that includes at least one optical chip having at least one first edge and at least one second edge and a plurality of optical waveguides extending therebetween, each of the first edge and the second edge having at least one input optical waveguide and at least one output optical waveguide adjacent thereto, a first array of optical fibers attached the first edge of the optical chip and in optical communication with the optical waveguides, and a second array of optical fibers attached to the second edge of the optical chip and in optical communication with the optical waveguides.

In another aspect, the invention is directed to an optical chip for use in an optical planar splitter that includes a base having a first edge and a second edge, at least one input optical waveguide extending from the first edge toward the second edge, at least one input optical waveguide extending from the second edge toward the first edge, at least two output optical waveguides extending from the second edge toward the first edge and being in optical communication with the at least one input optical waveguide extending from the first edge, and at least two output optical waveguides extending from the first edge toward the second edge and being in optical communication with the at least one input optical waveguide extending from the second edge.

Additional features and advantages of the invention are set out in the detailed description which follows, and in part and are readily apparent to those skilled in the art from that description or recognized by practicing the invention as described herein, including the detailed description which follows, the claims, as well as the appended drawings.

It is to be understood that both the foregoing general description and the following detailed description present exemplary and explanatory embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various exemplary embodiments of the invention, and together with the description, serve to explain the principles and operations of the invention.

### BRIEF DESCRIPTION OF THE DRAWINGS

FIG. 1 is a top view of one embodiment of an optical planar splitter with an optical chip according to the present invention;

FIG. 2 is a side view of one portion of the optical planar splitter of FIG. 1; and

FIG. 3 is top view of another embodiment of an optical planar splitter with another optical chip according to the present invention.

### DETAILED DESCRIPTION OF EXEMPLARY EMBODIMENTS

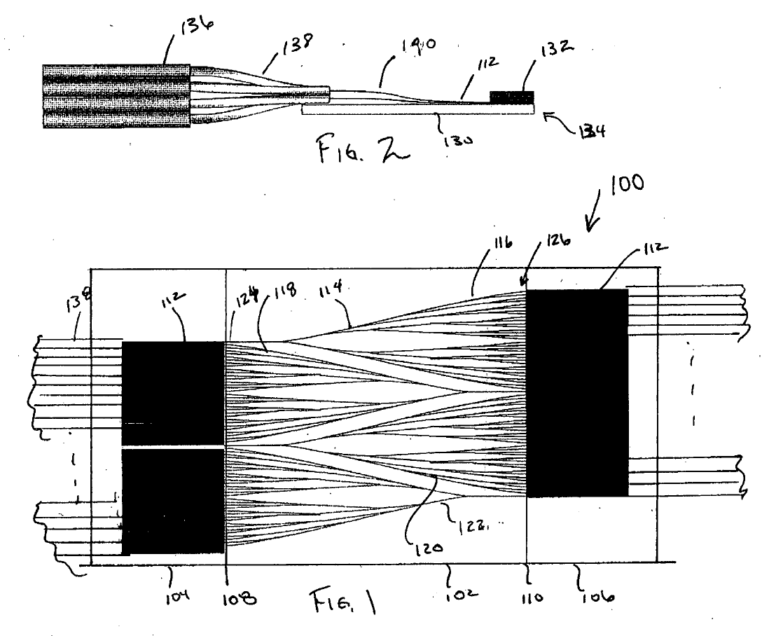

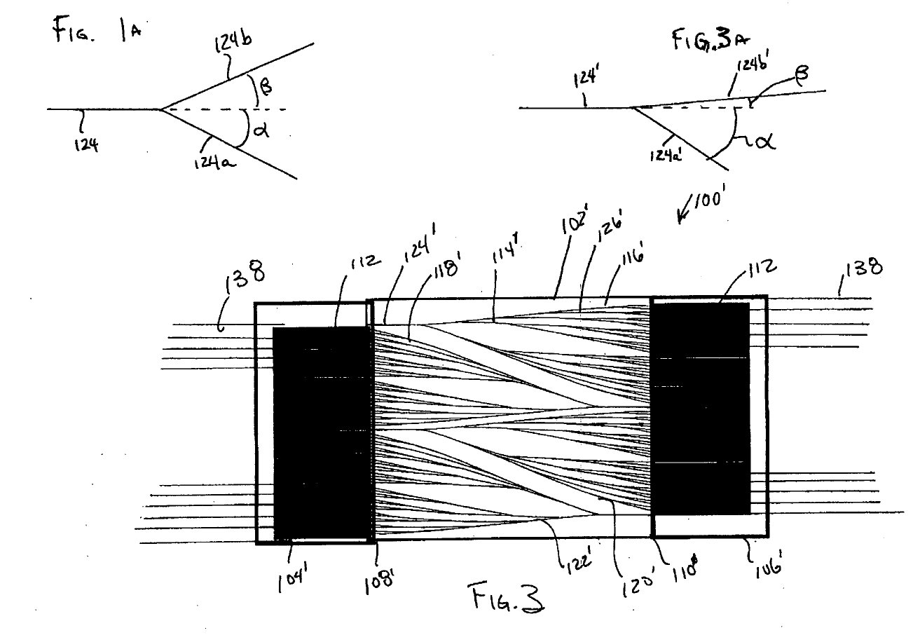

Reference will now be made in detail to exemplary embodiments of the invention, examples of which are described herein and shown in the accompanying drawings. Whenever practical, the same reference numerals are used throughout the drawings to refer to the same or similar parts or features. One embodiment of an optical planar splitter with an optical chip according to the present invention is illustrated in FIGS. 1 and 2 and is designated generally throughout the following detailed description by the reference numeral 100.

The optical planar splitter 100 has an optical chip 102 with two optical fiber arrays 104,106 attached along the edges 108,110 of the optical chip 102. Each of the optical fiber arrays 104,106 allows for multiple optical fibers 112 to be optically connected to the optical chip 102. The optical chip 102 preferably has a plurality of optical waveguides 114 extending between edge 108 and edge 110. The optical waveguides 114 are preferably divided into sets of optical waveguides.

In the embodiment illustrated in FIG. 1, there are four sets 116,118,120,122 of optical waveguides, however, there may be more or fewer. Each of the four sets 116,118,120,122 of optical waveguides is in optical communication with a respective input optical waveguide 124 and a plurality of output optical waveguides 126. As can be seen in FIG. 1, the four sets of optical wave guides are divided such that two input optical waveguides 124 are along each respective edge (108,110) of the optical chip 102, which then are divided into multiple output waveguides 126. The input waveguide, and thus the optical signal, can be divided into any number of output waveguides (and corresponding output optical signals). In the presently illustrated embodiment, the exemplary optical chip is a 1×32 optical chip, dividing each of the four input optical signals (two from each edge) into 32 output optical signals. Therefore, the optical chip has sixty-six optical waveguides along edges 108,110 of optical chip 102. The present invention is, however, not limited to 1×32 splitters and can be used to divide each input signal into 2, 4, 8, 16, or any other desired number of outputs (and thus have a corresponding number of output optical waveguides).

At the edges 108,110 of the optical chip 102, the optical waveguides 114 are each optically connected to an optical fiber 112 in one of the fiber arrays 104,106. One of the fiber arrays 104,106 according to one embodiment of the present invention is illustrated in FIG. 2. As illustrated, the optical fibers 112 are preferably attached to a base plate 130 of fiber array 104. The base plate 130 is preferably a glass plate, but may be made of any appropriate substrate material. The optical fibers 112 are preferably aligned on the base plate 130 by a v-groove plate 132, which is also preferably made of glass. The leading edge 134 of the fiber array is then polished, preferably at an 8° angle to allow for a better optical connection with an optical chip, whose edges are also polished at a complementary angle. The optical fibers 112 are preferably bonded to the base plate near the leading edge 124 with an adhesive. The optical fibers 112 may be in any format, including an optical fiber ribbon, single loose optical fibers, or, as illustrated in FIGS. 1 and 2, tight buffered optical fibers.

The optical fibers 112 in FIG. 2 that are attached directly to the plate 130 are preferably bare optical fibers, having a diameter of about 125-127 microns. However, in the depicted embodiment, the optical fibers are originally presented in a 2 mm tight buffered cable 136, which is then preferably stripped to 900 micron fibers 138, and then to 250 micron fibers before being made to be the bare optical fibers 112. As illustrated, the 900 micron fibers are preferably attached to the base plate 130 of the fiber arrays 104,106, preferably with epoxy, but any appropriate adhesive may be used. The 250 micron fibers are also attached to the base plate as well, thereby preventing as much stress on the bare optical fibers 112 as possible, particularly at the leading edge 124.

The 2 mm tight buffered cable 136 used for the output side of the optical planar splitter 100 for the embodiment of FIG. 1 approaches the optical fiber array in an 8×4 format. See FIG. 2. The 900 buffered fibers 138 are then collapsed to a 16×2 format at one edge of the base plate 130. Other configurations of the optical fibers used to mate with the optical waveguides on the optical chip 102 fall within the scope of the present invention. As noted briefly above, the optical fibers could be in a ribbon format (thereby being aligned generally in a single plane) or loose optical fibers. The fiber arrays 104,106 will also have an input optical fiber to align with the input optical waveguides on each side of the optical chip 102.

The sets 116,118,120,122 of optical waveguides 114 on optical chip 102 are configured on the optical chip 102 in a manner that allows them to be placed close to one another. As illustrated in FIG. 1, the optical waveguides 114 in set 116 have the input optical waveguide extending from edge 108 with the output optical waveguides extending from edge 110. The waveguides for set 118 are in the opposite orientation, with the input optical waveguide extending from edge 110 with the output optical waveguides along edge 108, allowing the two sets of optical waveguides to be disposed close to one another on optical chip 102, conserving space on the optical chip 102. It should also be noted that each of the sets 116,118,120,122 of optical waveguides are preferably symmetrically arranged about the input optical fibers. That is, sixteen of the output optical waveguides are aligned to one side of the input optical waveguide and sixteen of the output optical waveguides to the other side. This arrangement allows for the sets 116,118,120,122 of optical waveguides to be interfit with one another on the optical chip 102, using a minimal amount of space and achieving increased optical path density. This is especially true compared to an optical chip where the input optical waveguides are located along only one edge and all of the output optical waveguides were located along an opposite edge of the optical chip.

Another embodiment of a high density optical planar splitter 100′ is illustrated in FIG. 3. As with the previous embodiment, the optical planar splitter 100′ has an optical chip 102′, and at least two optical fiber arrays 104′,106′ attached along the edges 108′,110′. The optical fibers 112 and buffered fibers 138 are attached to the fiber arrays 104′,106′ as in the embodiment of FIG. 1. However, there are at least three major differences in this embodiment of optical planar splitter 100′. First, the optical waveguides 114′ extending between the edges 108′,110′ are arranged differently on the optical chip 102′. In each of the four sets 116′,118′,120′,122′ of optical waveguides, the input optical waveguide 124′ is optically connected to a plurality of output optical waveguides 126′, as with the previous embodiment. However, in this embodiment, the input optical waveguide 124′ optically connects to one output optical waveguide 126′ in a generally straight path. See, e.g., the top input and output waveguides in the top set 116′ of optical waveguides of FIG. 3. By orienting the output optical waveguides in this manner, the optical chip 102′ is narrower than the optical chip 102 of FIG. 1, particularly if the input optical waveguide 124′ is aligned with one of the outside output optical waveguides 126′, rather than an optical waveguide in the middle of the sets 116′,118′,120′,122′ of optical waveguides as in the previous embodiment. As shown in FIGS. 1A and 3A, the embodiments of FIGS. 1 and 3 include optical path angles α and β defined relative to the path of waveguides 124, 124a, 124b and 124′, 124a′, 124b′. In the embodiment of FIGS. 1 and 1A, the two optical path angles are approximately the same (i.e., α≈β), and in FIGS. 3 and 3A, one of the optical path angles is larger than the other (i.e., α>β. In a preferred embodiment of the present invention for high optical density applications, the optical path angle α≧β.

Second, the fiber arrays 104′,106′ are also aligned in the center of each side of the optical chip 102′ and are more narrow, reducing the need for materials. And, with the fiber arrays 104′,106′ being more narrow, they will also fit into the housings more easily.

Third, with the fiber arrays 104′,106′ being centered on the optical chip 102′, there is less stress and strain on the junction of the fiber arrays 104′,106′ with the optical chip 102′ with any forces exerted on the fiber optic cables that extend from either side of the optical planar splitter.

It will be apparent to those skilled in the art that various modifications and variations can be made in the optical planar splitter of the present invention without departing from the spirit or scope of the invention. Thus, it is intended that the present invention cover the modifications and variations of this invention provided they come within the scope of the appended claims and their equivalents.

1. An optical planar splitter comprising:
at least one optical chip having at least one first edge and at least one second edge and a plurality of optical waveguides extending therebetween, each of the first edge and the second edge having at least one input optical waveguide and at least one output optical waveguide adjacent thereto;
a first array of optical fibers attached to the first edge of the optical chip and in optical communication with the optical waveguides; and
a second array of optical fibers attached to the second edge of the optical chip and in optical communication with the optical waveguides.

2. The optical planar splitter according to claim 1, the optical chip having at least two sets of optical waveguides, each set of optical waveguides comprising one input optical waveguide and a plurality of output optical waveguides.

3. The optical planar splitter according to claim 2, wherein the at least two sets of optical waveguides comprises four sets of optical waveguides.

4. (canceled)

5. The optical planar splitter according to claim 2, wherein the input optical waveguide of one set of optical waveguides is adjacent the output optical waveguides of the other set of optical waveguides along one edge of the optical chip.

6. The optical planar splitter according to claim 1, wherein each edge of the optical chip has at least 10 waveguides therealong.

7. The optical planar splitter according to claim 2, wherein the input optical waveguide of at least one of the sets of optical waveguides is in optical communication with each of the corresponding plurality of output optical waveguides, and the plurality of output optical waveguides are symmetrical about the input optical waveguide.

8. The optical planar splitter according to claim 1, wherein the first array of optical fibers and the second array of optical fibers are asymmetrical relative to the optical chip.

9. The optical planar splitter according to claim 2, wherein the input optical waveguide of at least one of the sets of optical waveguides is in optical communication with each of the corresponding plurality of output optical waveguides, and the optical paths of one of the plurality of output optical waveguides and the input optical waveguide define a generally straight line.

10. The optical planar splitter according to claim 1, wherein the fist array of optical fibers and the second array of optical fibers are symmetrical relative to the optical chip.

11. The optical planar splitter according to claim 1, wherein the first and second array of optical fibers are in a ribbonized format.

12. The optical planar splitter according to claim 1, wherein the first and second array of optical fibers are tight buffered optical fibers.

13. An optical chip for use in an optical planar splitter comprising:
a base having a first edge and a second edge;
at least one input optical waveguide extending from the first edge toward the second edge;
at least one input optical waveguide extending from the second edge toward the first edge;
at least two output optical waveguides extending from the second edge toward the first edge and being in optical communication with the at least one input optical waveguide extending from the first edge; and
at least two output optical waveguides extending from the first edge toward the second edge and being in optical communication with the at least one input optical waveguide extending from the second edge.

14. The optical chip according to claim 13, wherein the first and second edges are polished and configured to each receive an optical fiber array.

15. The optical chip according to claim 13, wherein at least one input optical waveguide extending from the first edge toward the second edge comprises at least two input optical waveguides extending from the first edge toward the second edge; and
wherein the at least two output optical waveguides extending from the second edge toward the first edge comprises at least two sets of at least two output optical waveguides, each of the output optical waveguides in each set extending from the second edge toward the first edge and being in optical communication with a respective input optical waveguide.

16. An optical chip for use in an optical planar splitter comprising:
a base having at least one first edge and at least one second edge;
at least one input optical waveguide extending from the first edge toward the second edge and defining a first optical path;
at least one input optical waveguide extending from the second edge toward the first edge being in optical communication with at least two output optical waveguides extending from the first edge towards the second edge;
at least two output optical waveguides extending from the second edge towards the first edge being in optical communication with the input optical waveguide extending from the first edge and defining second optical paths; and
the first and second optical paths defining optical path angles α and β relative to the first optical path, such that optical path angle α≧β.
